(19) United States
(12) Patent Application Publication
(10) Pub. No.: US 2026/0181020 A1
(43) Pub. Date: Jun. 25, 2026

(54) Use of Secure-Session-Setup Signaling as a Basis to Facilitate Monitoring of Streaming-Media Exposure on per Server-Name Basis

(71) Applicant: The Nielsen Company (US), LLC, New York, NY (US)

(72) Inventors: Joseph Kerkes, Lutz, FL (US); Tiffany Dixon, New York, NY (US); Iztok Jakac, Zgornje Škofije (SI); Jernej Mihelj, Koper (SI); Julio Cesar Villasante, Tampa, FL (US)

(21) Appl. No.: 19/234,663

(22) Filed: Jun. 11, 2025

Related U.S. Application Data
(60) Provisional application No. 63/737,243, filed on Dec. 20, 2024.

(51) Int. Cl. H04L 9/40; H04L 65/1069

(52) U.S. Cl. CPC H04L 63/166; H04L 65/1069

(57) ABSTRACT

A method and system for use of secure-session-setup signaling as a basis to monitor subsequent packet-data communication. In an example implementation, a meter detects a secure-session-setup signaling packet between a client and a server. The meter reads from the packet a server IP address of the server and a server name of the server and establishes a correlation record correlating the server IP address with the server name. Thereafter, the meter detects packet-data communication between the client and the server IP address, the detected packet-data communication excluding a plaintext indication of a name of the server with which the client is communicating at the server IP address. The established correlation record then serves as a basis to determine that the name of the server is the server name specified by the correlation record, which may in turn facilitate recording data indicating that the client was communicating with that server.

### REFERENCE TO RELATED APPLICATION

This application claims priority to U.S. Provisional Patent Application No. 63/737,243, filed Dec. 20, 2024, the entirety of which is hereby incorporated by reference.

### SUMMARY

Disclosed herein is a method and system for use of secure-session-setup signaling as a basis to monitor subsequent packet-data communication. In an example implementation, a meter detects a secure-session-setup signaling packet between a client and a server. The meter reads from the packet a server IP address of the server and a server name of the server and establishes a correlation record correlating the server IP address with the server name. Thereafter, the meter detects packet-data communication between the client and the server IP address, the detected packet-data communication excluding a plaintext indication of a name of the server with which the client is communicating at the server IP address. The established correlation record then serves as a basis to determine that the name of the server is the server name specified by the correlation record, which may in turn facilitate recording data indicating that the client was communicating with that server.

These, as well as other embodiments, aspects, advantages, and alternatives, will become apparent to those of ordinary skill in the art by reading the following detailed description, with reference where appropriate to the accompanying drawings. Further, it should be understood that the disclosure provided in this summary and elsewhere in this document is provided by way of example only and that numerous variations and other examples may be possible as well.

### BRIEF DESCRIPTION OF THE DRAWINGS

FIG. 1 is a simplified block diagram of an example arrangement in which disclosed features could be implemented.

FIG. 2 illustrates how an on-device meter could be arranged to monitor for streaming-media events in an example implementation.

FIG. 3 is a flow diagram illustrating example operation.

FIG. 4 is another flow diagram illustrating example operation.

FIG. 5 is a flow chart illustrating an example method.

FIG. 6 is a simplified block diagram of an example device.

FIG. 7 is a simplified block diagram of an example computing system.

### DETAILED DESCRIPTION

In order to measure the extent to which people of various demographics engage with and/or are otherwise exposed to media content (e.g., linear broadcast content, non-linear streaming media content, websites, applications, etc.), a media-measurement company can arrange to have monitoring devices or “meters” operate in representative households or other sites and/or in applicable devices. People who have their media exposure monitored may be considered “panelists,” and the places where the monitoring occurs, such as home, offices, or other premises, may be considered “panelist sites.” Panelists may opt into and thus consent to this monitoring.

Meters can take various forms, including for instance (i) “presentation meters,” which may be configured to monitor presentation or playing of media by media-presentation devices such as televisions, computers, tablets, phones, gaming devices, smart speakers, radios, streaming-media players, set top boxes, and audio-visual receivers, and (ii) “streaming meters” (i.e., network-traffic meters), which may be configured to monitor network traffic such as but not limited to streaming-media-related traffic and web browsing traffic.

At each of various panelist sites having a media-presentation device, for example, the media-measurement company may arrange for a presentation meter to monitor media presentation by that device and to generate query signature data representing the presented media. Further, the media-measurement company may operate a back-end, cloud-based computing system, to receive and evaluate this presentation-meter-generated query signature data, in order to identify the media presented at the panelist site and thereby to establish associated media-exposure data.

By evaluating an audio line feed into the media-presentation device and/or by evaluating associated acoustic speaker output, a representative presentation meter at a panelist site may be configured to detect and extract watermarked identification codes from the audio and/or to generate digital audio fingerprint data representing component features of the audio, and to report the identification codes and/or fingerprint data, along with associated timestamps, as query signature data to the computing system for analysis. Such a presentation meter may also be configured to detect the power on or off state of the media-presentation device, so that the presentation meter can limit its media-presentation monitoring to times when the media-presentation device is on and therefore likely presenting media content being delivered to the media-presentation device.

The back-end computing system may then be configured to refer to reference signature data that maps various identification codes and/or fingerprint data to known media content items, in order to determine, based on the presentation-meter-reported identification codes and/or fingerprint data, what media content the media-presentation device was presenting at the indicated time. In particular, the computing system may be configured to search through the reference signature data in an effort to find reference signature data that matches the reported query signature data and, upon finding a match with sufficient certainty, to conclude that media content represented by the query signature data is the media associated with the matching reference signature data, and to establish associated media-presentation records for the panelist site, thus crediting the identified media content as being presented at the panelist site (e.g., as panelist-credited content).

Further, the computing system may be configured to correlate these media-presentation records with pre-stored demographics of the panelist and/or panelist site at issue, in order to establish associated media-exposure data, and the computing system may be configured to use this media-exposure data from multiple panelist sites as a basis to establish ratings statistics that may facilitate commercial processes such as ad placement and other content delivery.

In addition, at each of various panelist sites having a local area network (LAN) or otherwise supporting packet-based network communication or the like, the media-measurement company may arrange for a streaming meter to monitor and report to the back-end system information about network traffic at the panelist site. Further, the media-measurement company may also arrange for a streaming meter to be programmatically defined within a panelist's device, such as a smartphone, laptop, or other device, to likewise monitor and report to the back-end system information about network traffic at the panelist's device. Without limitation, this network traffic may include streaming-media-related traffic such as streaming-media control communications and ongoing streaming-media sessions.

Monitoring streaming-media-related traffic in particular may help to facilitate media measurement (e.g., audience measurement) related to media streaming from Over The Top (OTT) streaming-media service providers or the like.

For instance, when query signature data provided by a presentation meter matches reference signature data representing non-linear streaming-media content and the computing system therefore credits that streaming-media content as having been presented at the panelist site, it may also be useful for the computing system to identify the source of that streaming-media content. Including this source information as part of the media-exposure data may enhance the data and associated ratings statistics and may facilitate useful action keyed to the source. For example, knowledge that panelists (e.g., of particular demographics) have been exposed to content provided by a particular OTT service provider may support a decision to arrange for that OTT service provider to distribute particular ads and/or other content, among other possibilities.

Further, even regardless of what particular streaming-media content the panelist site was receiving at the time, it may be useful for the computing system to determine that the panelist site was receiving streaming media from a particular OTT service provider. Likewise, when the panelist's device receives and presents streaming media, it may be useful for the computing system to determine that the panelist's device was receiving that streaming media from a particular OTT service provider. That information, in conjunction with panelist demographics information and/or other information, may similarly support decisions to arrange for the OTT service provider to distribute particular ads and/or other content, among other possibilities.

To facilitate monitoring network traffic at a panelist site and/or in a panelist's device, it would be useful to situate the streaming meter within a network communication path through which traffic of interest would flow, so that the streaming meter would have a view of that traffic.

In an example implementation, the traffic of interest may include packet-based internet communications to and/or from a given media-presentation device (such as one of those noted above) or other client device. Therefore, it may be useful to situate the streaming meter within a network communication path through which those packet-based communications would flow. For example, if a representative client device sits as a node on a panelist-site LAN and engages in internet communications through that LAN, it could be useful to situate the streaming meter as a node on the panelist-site LAN (e.g., as a dedicated device, or integrated with another LAN node) and to have the client's internet traffic flow through that streaming meter node. Alternatively, it could be useful to configure the streaming meter programmatically as an on-device meter (ODM) within the client device, to enable the meter to monitor the device's packet-based traffic without a need for an external (e.g., LAN-based) streaming meter.

The streaming meter may then monitor network traffic flowing to and/or from the client device and may report associated information to the back-end system, to enable the back-end system to factor that information into its analysis and associated operations. With this information, for instance, the back-end system may be able to identify times when a client device was receiving streaming media, and the back-end system may be able to determine the source of that streaming media, which may facilitate useful associated operations as discussed above. Further, with this information, the back-end system may be able to establish other media-exposure data related to websites visited, online games played, and/or other network services used, among other possibilities.

Setting up and/or carrying out of a streaming-media session from a streaming-media server to a client device may make use of Hypertext Transfer Protocol Secure (HTTPS) and other signaling between client and the server.

The process may begin when a media application on the client device receives user input requesting streaming and playout of a particular media-content item. In response to this user request, the media application may generate and pass to an operating system of the client device an HTTPS request message that carries a Universal Resource Locator (URL) specifying a domain name of the associated streaming-media server and specifying the requested media-content item to be streamed. On receipt of this HTTPS message, the operating system may then transmit to a Domain Name Servicer (DNS) server a request to translate the URL-specified domain name into an IP address and may receive in response from the DNS server an indication of the IP address. The operating system may then process the HTTPS message to facilitate transmitting the message to that IP address.

To facilitate HTTPS messaging between the client and the streaming-media server at the indicated IP address, the operating system may first work to establish a secure (encrypted) connection between the client and the server. In particular, when the operating system receives an initial HTTPS message to transmit to the server, the operating system, at a transport-layer, may establish a Transport Control Protocol (TCP) connection with a transport layer of the server (e.g., by engaging in standard SYN, SYN-ACK, and ACK handshake) and then through that TCP connection may engage in Transport Layer Security (TLS) signaling with the server to secure the transport-layer connection, i.e., to establish a secure connection between the client and the server.

The TLS signaling may involve a multi-message handshake (message exchange) between the client and server. This handshake may begin with the client sending to the server a “Client Hello” message that indicates a supported TLS version, a list of supported cipher suites, and a client-generated random string of bytes. The server may then respond to the client with a “server hello” message containing the server's Secure Socket Layer (SSL) certificate, a chosen cipher suite, and a server-generated random string of bytes. After the client verifies the server's SSL certificate, the client and server may then engage in further signaling with each other to establish session-key information that will be used for their secure communications.

Once the client and server have established their secure connection, the client may then encrypt the media application's HTTPS request message and transmit the encrypted HTTPS request message to the IP address of the server. The server may then send to the client an encrypted HTTPS response message carrying a manifest file that lists chunks of the media-content item that are available for streaming and that provides a URL per chunk. To engage in the streaming media-session, the client may then sequentially transmit encrypted HTTPS request messages for the respective chunks in sequence, the server may respond to each encrypted HTTPS request by transmitting the requested chunk, and the client may buffer and play out the chunks in real-time as the client receives them.

In an example implementation, a streaming meter may be configured to detect and report various communication events related to presentation of media on such a client device, and thus related to panelist exposure to that media, among other possibilities. For instance, the streaming meter may be configured to detect and report streaming-media events including (i) domain events and (ii) bandwidth events.

Domain events may comprise occurrences of communication between the client device and a server having a particular domain name, also known as a server name. This server name may be the name of a particular service that could serve the client device with media that the client device may present and thus to which a panelist may be exposed. For instance, the server name may be the name of a particular streaming-media server and thus a particular streaming-media service such as an OTT server, which may be arranged to stream media content upon request to the client device.

Examples of domain events include, without limitation, control signaling and media communication between the client device and the server. Control signaling between the client device and the server could include signaling such as the HTTPS messaging noted above, as well as other-protocol signaling between the client device and the server. Media communication between the client device and the server, which may overlap in part with the control signaling, may include packet-data flow carrying streaming media or other types of media from the server to the client device.

By monitoring packet-data communications to/from the client device, the streaming meter may be able to detect these or other domain events, and the streaming meter may create timestamped domain-event records indicating the detected events. Further, the streaming meter may report these domain-event records to the back-end system, to enable the back-end system to factor into its media-exposure analysis this information indicating that the client device was in communication with a particular domain at a particular time, such as at a time when the back-end system also finds that the client device was presenting particular media.

Bandwidth events, on the other hand, may comprise occurrences of packet-data flow having a particular pattern indicative of a type of communication of interest. By way of example, a bandwidth event may be the occurrence of packet-data flow to the client device when the packet-data flow has a pattern indicative of the client device receiving streaming media transmission, such as streaming video transmission for instance.

A pattern of streaming could be defined in various ways, and the streaming meter may thus monitor for and detect a pattern of streaming in various ways. By way of example, the streaming meter may monitor packet-data flow (e.g., on a per-domain basis, such as on a per source-IP-address basis) in short periods (e.g., 3, 5, 10, or 12 second periods) and may detect the presence of a pattern of streaming at times when (i) there is at least a predefined threshold number (e.g., 5, 6, 7, or 8) such periods of data contiguously from the same domain as each other, (ii) at least one of the threshold number of periods has at least a threshold high peak data rate (e.g., 30 kilobytes per second, 50 kilobytes per second, 100 kilobytes per second, or 1,000 kilobytes per second), and (iii) the minimum average data rate over the course of the detected periods is at least a predefined threshold high data rate (e.g., at least 10 kilobytes per second, at least 30 kilobytes per second, at least 100 kilobytes per second, or at least 1,000 kilobytes per second).

By monitoring packet-data communications to the client device, the streaming meter may be able to detect these or other bandwidth events, and the streaming meter may similarly create timestamped bandwidth-event records indicating the detected events. Further, the streaming meter may report these bandwidth-event records to the back-end system, to enable the back-end system to factor into its media-exposure analysis this information indicating the occurrence of particular bandwidth events at particular times.

As to streaming media by way of example, the back-end system may be able to correlate domain events and bandwidth events reported by the streaming meter, as to a given client device. For instance, the back-end system may determine from reported domain events that the client device was engaged in communication with a particular server. Further, the back-end system may determine from reported bandwidth events that the client device was engaged in a particular type of communication with the server, such as that the client device was receiving streaming media from the server.

A technical problem with this process, however, is that much of the packet-data communication between the client device and the server may not indicate which server the client device is communicating with. The communications may indicate the IP address of the server. However, that IP address may not clearly correlate with the server at issue.

For instance, HTTPS messages that pass between the client device and the sever may be carried in IP packets noting in plaintext the source and destination IP addresses, but any indication of server name, in a URL within the HTTPS message for instance, may be encrypted. Therefore, while the streaming meter could detect these packets and determine the IP address, the streaming meter would likely be unable to determine from these packets the name of the server with which the client device is communicating. Further, packet-data flow such as streaming media flowing from the server to the client device may specify the server's IP address but would also likely not specify the server name. Therefore, the streaming meter may likewise be unable to determine the name of the server transmitting those packets to the client device.

If the streaming meter earlier detects the DNS signaling noted above, the streaming meter may be able to determine from that DNS signaling a mapping between the server name (domain name) and the server's IP address. The streaming meter and/or back-end system could then in theory apply that mapping to determine that later communications with that IP address are communications with that server name.

However, a further technical problem exits with this process: in some cases, multiple server names may be mapped to the same IP address as each other. For instance, a streaming-media provider may operate multiple streaming-media services, each having its own respective server name, but all accessible at the same physical server having a given IP address. (For instance, one of these server names may be mapped directly to the IP address, and each other server name may be mapped to that main server name and thus indirectly to the IP address).

In this or other situations, based on earlier DNS messaging, the streaming meter and/or back-end system may have records correlating each of multiple server names with the same server IP address as each other. Therefore, when the streaming meter detects a domain event keyed to that server IP address, it may be unclear which server name the client device is communicating with at that time.

In an implementation where the streaming meter would include in its domain-event reports to the back-end system an indication of the server name with which the client device was communicating, the streaming meter may encounter this ambiguity and may therefore need to specify in its domain-event report the multiple possible server names. Alternatively, in an implementation where the streaming meter has reported DNS mappings to the back-end system and would then include in its domain-event reports to the back-end system an indication of server IP address, the back-end system may itself encounter this ambiguity, being unable to determine which of the multiple server names was at issue.

One way or another, this would create a problem, as the back-end system may be unable to reliably factor into its media-exposure analysis an indication of the name of the server with which the client was communicating.

The present disclosure provides a technical mechanism to help overcome this issue. The disclosed mechanism leverages the fact that, when a client device engages in signaling with a server to establish a secure transport-layer connection through which the client and server will then engage in encrypted communication such as HTTPS messaging, that signaling may specify in plaintext the name of the server with which the client is seeking to communicate. In accordance with the disclosure, a streaming meter situated in the path of the client's packet-data communications may therefore read that plaintext server name from the client device's secure-session-setup signaling, and the streaming meter may report that server name to the back-end system to facilitate improved media-exposure analysis.

In an example implementation, the secure-session-setup signaling used for this purpose could be the TLS signaling discussed above. By way of example, in accordance with the “Server Name Indication” (SNI) extension of the TLS protocol, the “Client Hello” message that the client device sends at the start of the TLS handshake process can carry in plaintext the name of the server that the client device is trying to connect with. A reason for this SNI extension is to help enable the server determine which of possibly multiple SSL certificates the server should present to the client device. Namely, when the server receives a “Client Hello” message that indicates the server name in an SNI extension field, the server can responsively provide the client device with the SSL certificate for that server name in particular.

As presently contemplated, a streaming meter can make use of this SNI information to determine the name of the server that a client device will be communicating with. For instance, the streaming meter may use this SNI information as a basis to determine a server name of a particular streaming-media server with which the client will be communicating. The streaming meter may then report this determined server name to the back-end system, to facilitate correlation with subsequently reported streaming-media events, or streaming meter may include this server name in the streaming meter's subsequent streaming-media-event reports to the back-end system.

In an example implementation, after the client device establishes a TCP connection with the server, the client device may then send the “Client Hello” message as payload in a TCP message to the server, to initiate the TLS handshake process. In particular, the client device may transmit to the server an IP packet that encapsulates a TCP datagram carrying a TLS message, with the TLS message including in an SNI field a plaintext specification of the server name, such as streaming-media-service.example.com, or stocks-data-service.example.com, for instance.

In an example scenario where the streaming meter is located on LAN at a panelist site, the streaming meter may receive this IP packet encapsulated in an Ethernet frame. The Ethernet frame may include a header that specifies, among other information, a source Media Access Control (MAC) address of the client device. Further, the IP packet may include a header that specifies the client's IP address as a source IP address and the server's IP address as destination IP address. The TCP datagram may then specify TCP port information and may carry TLS data including, at a TLSv3 or other Record Layer for instance, the “Client Hello” message. The “Client Hello” message may then include an extension of type “server_name” that has a “Server Name” field in which the client device may include a specification of the name of the server with which the client is seeking to communicate.

A streaming meter that has a view of packet-data communications by this example client device may detect this “Client Hello” message from the client device. For instance, the streaming meter could monitor packet-data traffic in search of a packet that carries a “Client Hello” message, possibly specifically from the MAC address and/or IP address of this client device, and, upon detecting such a packet, the streaming meter may extract information from the packet in order to construct a domain-event record that the streaming meter may then report to the back-end system.

In an example of this process, the streaming meter may extract, from the detected packet, information such as (i) the client's MAC address, (ii) the client's IP address, (iii) the server's IP address, and (iv) the server name indicated in the SNI extension field. Provided with this information, the streaming meter may then establish a timestamped domain-event record (e.g., using extensible markup language (XML)) that specifies this extracted information, and the streaming meter may report this domain-event record to the back-end system.

This domain-event record may usefully correlate the indicated server IP address with the indicated server name, for purposes of packet-data communications with the client device in particular. Therefore, as the client device thereafter engages in communications with that particular server IP address, even if those communications do not specify the server name (or do not specify the server name in a manner readable by the streaming meter), the streaming meter and/or back-end system could determine that the server name.

For instance, when the streaming meter detects a packet carrying an HTTPS message, streaming-media, or other data en route between the client device and the server IP address, the streaming meter may read from that packet the server IP address and, based on the earlier domain-event record that correlates the server IP address with the server name that the streaming meter extracted from the SNI field, the streaming meter may generate and report to the back-end system an event record (e.g., streaming-media-event record or other communication-event record) indicating that that particular packet-data communication was with the server having that server name. Based on this report, the back-end system may then usefully factor this server name into its media-exposure analysis.

Alternatively, when the streaming meter detects a packet carrying an HTTPS message, streaming media, or other data en route between the client device and the server IP address, the streaming meter may read from those packets the server IP address and may generate and report to the back-end system an event record indicating that that particular packet-data communication was with the server having that IP address. Based on the back-end system's earlier receipt of the domain-event report that correlated the server IP address with the server name that the streaming meter extracted from the SNI field, the back-end system may then determine that the new event report specifying the server IP address is a report that the client device was communicating with the server having that server name. The back-end system may then likewise usefully factor this server name into its media-exposure analysis.

By making use of the server name that was indicated in plaintext in TLS or other secure-session-setup signaling between the client device and the server, this process can thereby enable the back-end system to learn that that the client device was in communication with a particular server having that server name, which may facilitate generation of more robust media-exposure data. For instance, as noted above, the back-end system may be able to generate media-exposure statistics related to media provided by that server in particular, which may facilitate useful action such as placement of advertisements in content served by that server in the future, among other possibilities.

Note that the determined correlation between server IP address and server name, as to communications with a particular client device, can stand for a predefined period of time and/or until a later determination is made that the client device is communicating with a different server name.

For instance, once the streaming meter determines this correlation based on information in the secure-session-setup signaling between the client device and a first server having a first server name, the streaming meter may make a record of the determined correlation and may set a lifetime timer for that correlation. Until expiration of that lifetime timer or other change in the correlation, the streaming meter may then deem communications between the client device and the server IP address to be communications between the client device and the server having the first server name. Thus, as to communications between the client device and that server IP address, the streaming meter may specify that first server name in the streaming meter's event reports to the back-end system. Upon expiration of the lifetime timer, the streaming meter may then delete that correlation and wait to determine a new correlation.

Likewise, if the streaming meter reports to the back-end system the determined correlation between the server IP address and the first server name as of a particular timestamp, then the back-end system may make a record of that correlation and set a lifetime timer from that timestamp for the correlation. Until expiration of that lifetime timer or other change in the correlation, the back-end system may then deem streaming-meter reports of communication between the client device and the server IP address to be reports of communications between the client device and the server having the first server name. Upon expiration of the lifetime timer in relation to timestamps of the streaming meter's reports, the back-end system may then delete the correlation and wait to receive a report of a new correlation.

Furthermore, after the streaming meter has established for the client device a correlation of the server IP address with a first server name based on information in the secure-session-setup signaling between the client device and the first server at the IP address, the streaming meter may change the correlation based on new secure-session-setup signaling between the client device and a second server at the same IP address.

For instance, the streaming meter may thereafter detect a packet, from the client device to the server IP address, that carries a new “Client Hello” message but with the “Client Hello” message carrying in the SNI field a second server name instead of the first server name. In response to detecting this packet and the packet specifying the second server name at the same server IP address, the streaming meter may thus conclude that the client device is switching to engage in communication with the server having the second server name. Therefore, the streaming meter may update the streaming server's recorded correlation, for the client device, to now correlate the server IP address with the second server name. Further, the streaming meter may also responsively report this new correlation to the back-end system. The streaming meter and/or back-end system may then make use of this revised correlation as noted above.

Accordingly, an example method could involve a streaming meter detecting a packet en route between a client device and a server, the packet carrying secure-session-setup signaling to facilitate setup of a secure connection (e.g., secure TCP connection) between the client device and the server. The method could further involve the streaming meter reading from the detected packet a server IP address of the server and a server name of the server. For instance, the secure-session-setup signaling could comprise a “Client Hello” message, the streaming meter could read the server IP address from an IP header of the packet, and the streaming meter could read the server name from an SNI-extension field in the “Client Hello” message.

The method could then involve, based on the reading of the server IP address and server name, the streaming meter making a correlation record that specifies for the client device a correlation of the server IP address with the server name. Further, the method may involve the streaming meter reporting this correlation record to a back-end system.

The method could then additionally involve the streaming meter thereafter detecting packet-data communication en route between the client device and the server IP address, the detected packet-data communication excluding a plaintext indication of a name of the server with which the client device is communicating at the server IP address. Further, the method could involve the streaming meter using the correlation record a basis to determine that the name of the server is the server name specified by the correlation record. The method could then involve, based on this determined correlation and the detected packet-data communication, the streaming meter reporting to the back-end system that the client device was engaged in the packet-data communication with a server having the determined name. Further, the method could involve, based on this reporting that the client device was engaged in the packet-data communication with the server having the determined name, the back-end system establishing media-measurement data and then using the established media-measurement data as a basis to take useful action.

Alternatively or additionally, the method could involve the streaming meter thereafter detecting packet-data communication en route between the client device and the server IP address, the detected packet-data communication excluding a plaintext indication of a name of the server with which the client device is communicating at the server IP address. Further, the method could involve the streaming meter reporting to the back-end system that the client device was engaged in the packet-data communication with a server having the server IP address, and, based on this reporting and based on the earlier reported correlation between the server IP address and the name, the back-end system determining that the client device was engaged in the packet-data communication with a server having that name. Here too, the method may then involve, based on this information, the back-end system establishing media-measurement data and then using the established media-measurement data as a basis to take useful action.

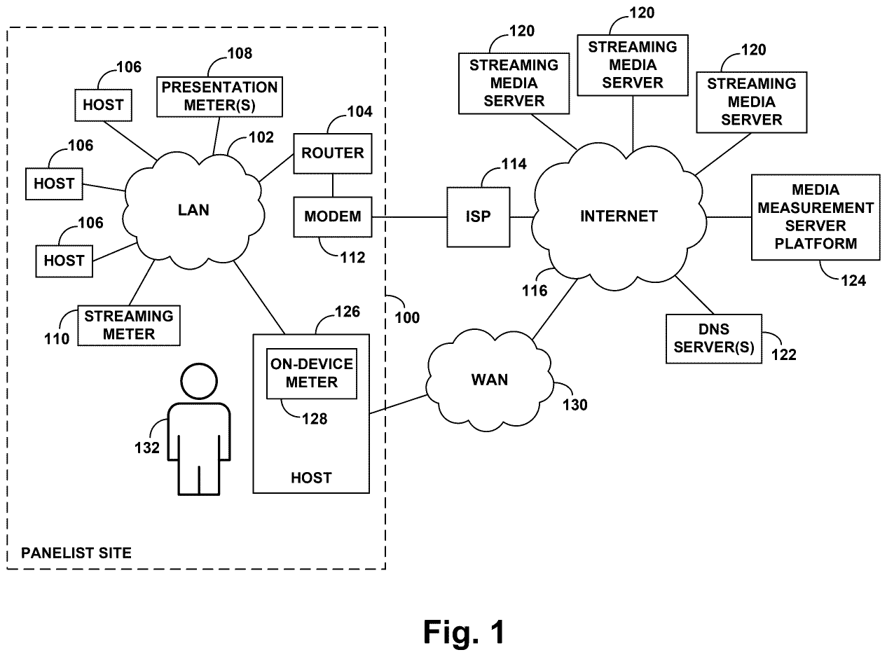

Referring to the drawings, as noted above, FIG. 1 is a simplified diagram of an example arrangement in which various disclosed features could be implemented. It will be understood, however, that this and other arrangements and processes disclosed herein could take various other forms. For instance, elements and operations could be re-ordered, distributed, replicated, combined, omitted, added, or otherwise modified. Further, elements described as functional entities could be implemented as discrete or distributed components or in conjunction with other components/modules, and in any suitable combination and location. Still further, various operations described as being carried out by one or more entities could be implemented by and/or on behalf of those entities, through hardware, firmware, and/or software, such as by one or more processing units executing program instructions stored in memory, among other possibilities.

As shown in FIG. 1, the example arrangement includes at a panelist site (e.g., home, office, etc.) 100 an example packet-switched LAN 102 having a number of LAN nodes including but not limited to a router 104, one or more hosts of interest (e.g., media presentation devices) 106, one or more presentation meters 108, and an example streaming meter 110. These nodes may be connected to the LAN through wired (e.g., Ethernet) and/or wireless (e.g., Wi-Fi) links. Further, as noted above, the streaming meter 110 could be provided as a separate device or alternatively as logic within another device, possibly integrated with a presentation meter 108 or within a host device 106 for instance.

As shown, the router 104 is connected with a modem 112, which provides connectivity with an internet service provider (ISP) 114, to facilitate communication on the internet 116. Alternatively, the router 104 may be integrated with the modem 112.

Shown accessible through the internet 116 (e.g., at particular public IP addresses on the internet) are then multiple network resources such as streaming-media servers 120 and one or more Domain Name System (DNS) servers 122. Further, also shown accessible through the internet 116 is a media-measurement server platform 124, which may be operated by an example media-measurement company.

In practice, the streaming meter 110 may have a view of packet-data communications flowing to and/or from the one or more hosts 106 on the LAN 102, so that the streaming meter 110 can detect streaming-media events such as control communication between a host 106 and a streaming-media server 120 and high-bandwidth packet-data flow indicative or at least suggestive of a host receiving streaming-media. For instance, as described by U.S. patent application Ser. No. 18/824,108, filed Sep. 4, 2024 (the entirety of which is hereby incorporated by reference), each host 116 when connected with the LAN 102 may be set to route its packet-data communications through the streaming meter 110, so that streaming-media-related communications to/from the host 116 may flow through the streaming meter 110, and the streaming meter 110 may therefore detect those communications and accordingly report streaming-media events to the media-measurement server platform 124.

Without limitation, example streaming-media events that the streaming meter 110 may detect may include a domain events and a bandwidth events described above. Having a view of network traffic on the LAN 102, the streaming meter 110 may detect these or other streaming-media events based on packet-data communications to and/or from the host 116.

A representative domain event may be where the host 116 engages in packet-data communication with a particular server name of or associated with a streaming-media server 120, such as packet-based communication to set up and/or control a streaming-media session from the server 120 to the host 116, among other possibilities. The streaming meter 110 may be able to detect such a domain event if the server can detect messaging flowing between the host 116 and the server name and IP address of the streaming-media server 120.

A representative bandwidth event may be where the host 116 receives packet-data flow that has a pattern of streaming, i.e., a pattern of packet-data flow that is suggestive of the host 116 receiving streaming media transmission. As noted above, such as pattern of streaming could be defined in various ways, and the streaming meter 110 may thus monitor for and detect a pattern of streaming in various ways.

In line with the discussion above, as the streaming meter 110 detects these or other streaming-media events, the streaming meter 110 may record the events along with associated timestamps, for reporting to the media-measurement platform 124. The streaming meter 110 may then report these detected events either in real time or periodically, such as every hour, every day, or the like, to facilitate processing by the platform 124.

Continuing with reference to FIG. 1, further shown in the panelist site 100 is an example host device 126 that may alternatively include its own on-device meter (ODM) 128. This example host device 126 is shown sitting as a node (through a wired or wireless connection) on the LAN 102 and alternatively or additionally having its own separate wide area network (WAN) connection 130 with the internet 116, to facilitate engaging in packet-data communication with entities such as the streaming media servers 120 and the media-measurement platform 124. Examples of this WAN connection 130 may include a cellular-wireless-network connection, a hybrid-fiber-coaxial (HFC) network connection, and a satellite-network connection, among other possibilities.

In some implementations, this example host device 126 may be operated by an example panelist 132 as shown. By executing a media player application or other program logic upon request of the panelist 132, the example host device 126 may engage in packet-data communications with a streaming-media server 120 (or an associated server), to set up and/or control a streaming media session provided by that server 120 and to receive and play streaming media for consumption by the panelist 132.

To help ensure that the media-measurement platform 124 learns about this streaming media activity, in line with the discussion above, the ODM 128 of the host device 126 can function as a streaming meter with respect to packet-data communications to/from the host device 126. For instance, this ODM 128 may operate as a streaming meter to detect streaming-media events such as the domain events and bandwidth events noted above, and to report the detected events to the media-measurement platform 124. This can be especially helpful in a scenario where the host device 126 is WAN connected and where the streaming meter 110 on the LAN 102 therefore has no view of the network traffic. But the ODM 128 may also operate even if the host device engages in communication through the LAN.

The remainder of this disclosure will address an example scenario where the meter at issue is ODM 128. However, it will be understood that the same principles can apply with respect to the external streaming meter 110 and/or in other arrangements.

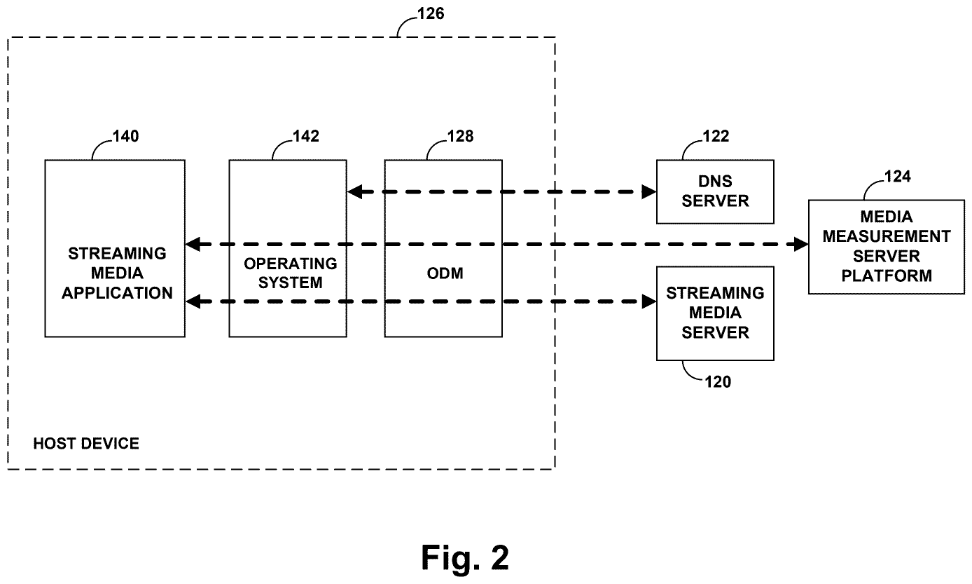

FIG. 2 illustrates generally how the ODM 128 in the host 126 may operate as an example of an intermediary with respect to packet-data communications that flow to and/or from the host 126. As shown in FIG. 2, the host 126 may include a streaming-media application 140, an operating system 142, and the ODM 128, with the ODM 128 being situated logically in a path of communications between the operating system 142 and external entities such as the streaming-media servers 120, the DNS server 122, and the media measurement server platform 124.

With this arrangement, the application 140 may respond to input from the panelist 132 by working to initiate a streaming media session from an example streaming-media server 120, such as “stocks-data-service.example.com” for instance.

To do so, as discussed above, the application 140 may generate and send to the operating system 142 an HTTPS request carrying a destination Universal Resource Locator (URL) that specifies a domain name of the streaming-media server 120 (or an associated server) and that designates the particular media item to be streamed, among other possibilities. The operating system 142 may then resolve that domain name to an IP address by generating and transmitting an associated DNS query to the DNS server 122 and receiving in response from the DNS server 122 an indication of the IP address. The operating system 142 may then process the HTTPS request down a networking protocol stack, ultimately transmitting the request to the server 120.

In line with the discussion above, to send this HTTPS request message to the streaming-media server 120 at the indicated IP address, the operating system 142 may first engage in TLS signaling with the server 120 to set up a secure TCP session between the host device 126 and the server 120. As noted above, this may involve the operating system 142 sending to the server 120 a “Client Hello” message that includes in an SNI field a plaintext specification of the server name at issue. For instance, with the example noted above, the SNI field may specify that the server name is “stocks-data-service.example.com.”

Once the host device 126 and server 120 have established their secure TCP connection, the operating system 142 may then accordingly encrypt and transmit the HTTPS request message to the server 120 through that secure TCP connection. In turn, the server 120 may then respond to the host device 126 with an encrypted HTTPS response message carrying a manifest file that lists chunks of the media-content item that are available for streaming and that provides a URL per chunk. And to engage in the streaming media-session, the host device 126 may then sequentially transmit encrypted HTTPS request messages for the respective chunks in sequence, the server 120 may respond to each encrypted HTTPS request by transmitting the requested chunk, and the application 140 may buffer and play out those chunks in real-time as the host device 126 receives them.

As these and possible other encrypted communications are communicated between the host device 126 and the server 120, the communications would pass through the ODM 128. The communications would specify in plaintext the IP address of the server 120 (e.g., as destination for outgoing IP communications or as source IP address for incoming communications). However, the name of the server 120 may be encrypted, e.g., in an HTTPS URL in accordance with the secure TCP session between the host device 126 and the server 120.

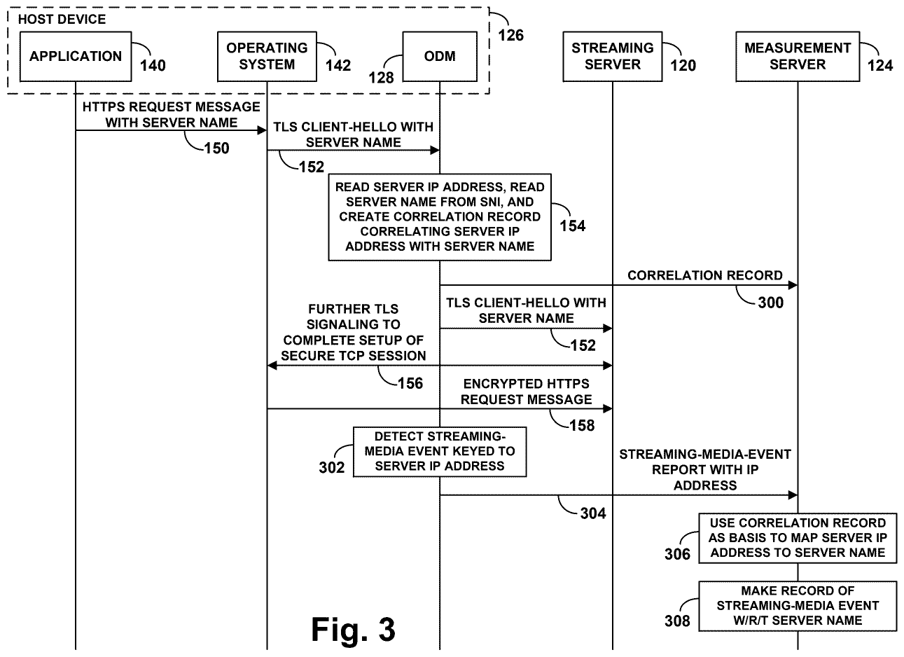

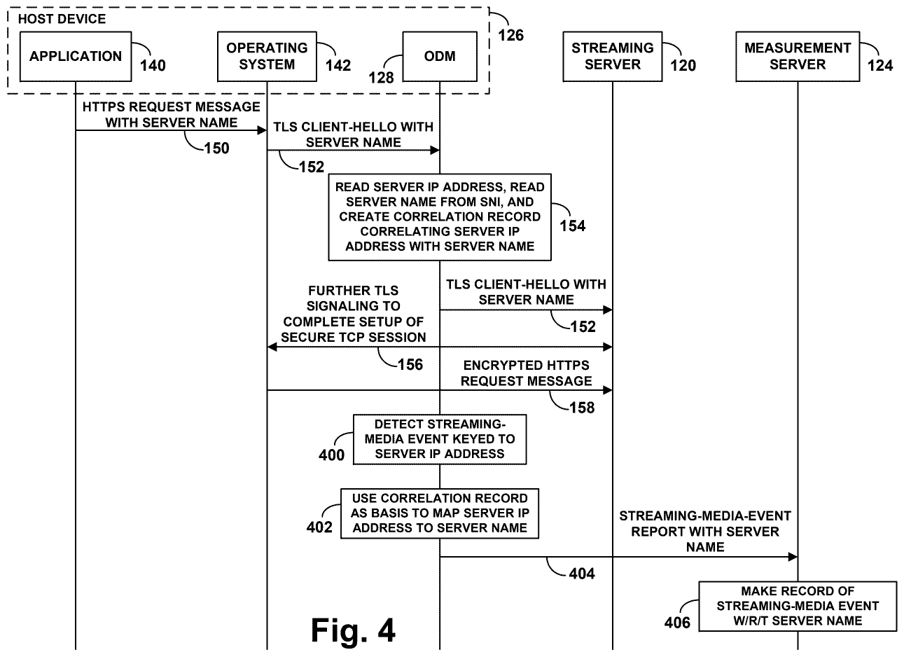

In line with the discussion above, to facilitate mapping of the server IP address to the applicable server name, for purposes of determining which server the host device 126 is communicating with (or which server the host device 126 was communicating with at the time), the ODM 128 may use the initial TLS signaling between the operating system 142 and the server 120 as a basis to establish a correlation record. That correlation record may then be used as a basis to determine the server name based on the IP address. FIGS. 3 and 4 illustrate two example implementations of this process.

As shown in FIGS. 3 and 4, at step 150, the application 140 sends to the operating system 142 an HTTPS request message including a URL that designates the name of a server 120 to receive the HTTPS request message. At step 152, the operating system 142 then sends to the IP address of the server 120 a TLS “Client Hello” message that specifies in the SNI field the server name with which a secure TCP session is being established. At step 154, as this “Client Hello” message passes through the ODM 128, the ODM 128 reads the server IP address from the packet header and reads the server name from the SNI field of the message, and the ODM 128 creates a correlation record that correlates that server IP address with that server name.

At step 156, the operating system 142 and server 120 then engage in further TLS signaling to complete setup of a secure TCP session. And at step 158, the operating system 142 then encrypts and transmits the HTTPS message to the server 120 in accordance with the secure TCP session.

In the implementation of FIG. 3, at step 300, the ODM 128 reports this correlation record to the media measurement server platform 124 for use by the server platform 124 to facilitate mapping the server IP address to the server name. Thereafter, at step 302, the ODM 128 detects a streaming-media event such as a domain event or bandwidth event, with the event being keyed to the server IP address but not indicating in plaintext the server name. At step 304, the ODM 128 reports this streaming-media event to the media measurement server platform 124, including the server IP address. And at step 306, the media measurement server platform 124 then uses the previously received correlation record as a basis to map the server IP address to the server name, so as to determine the name of the server with respect to which the reported streaming-media event occurred. At step 308, the media measurement server platform 124 may therefore make a record, for the host device 126, of the detected streaming-media event with respect to that particular server name, which may form the basis to establish server-name-based media-exposure data, among other possible actions.

In the implementation of FIG. 4, on the other hand, at step 400, the ODM 128 detects a streaming-media event such as a domain event or bandwidth event, with the event being keyed to the server IP address but not indicating in plaintext the server name. At step 402, the ODM 128 then uses the previously established correlation record as a basis to map the server IP address to the server name, so as to determine the name of the server with respect to which the streaming-media event occurred. At step 404, the ODM 128 then reports to the media measurement server platform 124 the streaming-media event including an indication of the determined server name. At step 406, the media measurement server platform 124 then makes a record, for the host device 126, of the detected streaming-media event with respect to that particular server name, which may form the basis to establish server-name-based media-exposure data, among other possible actions.

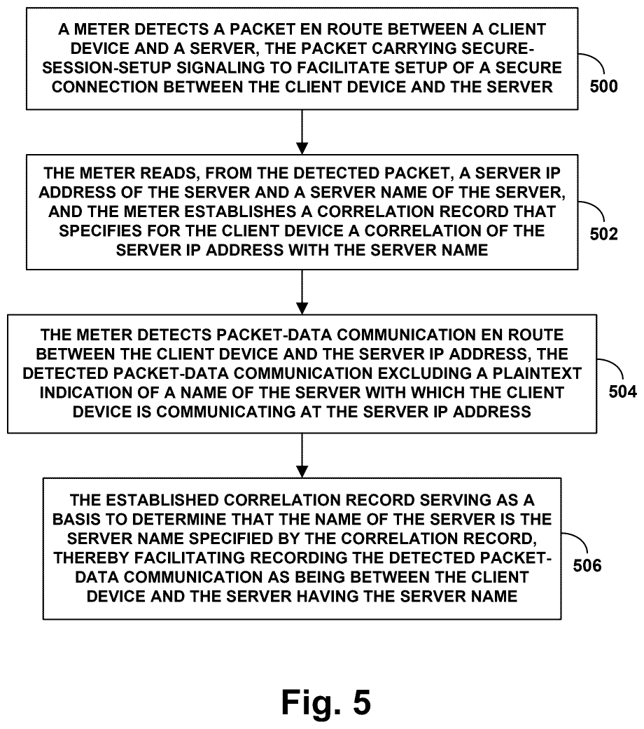

FIG. 5 is a flow chart illustrating an example method. As shown in FIG. 5, at block 500, the example method includes a meter detecting a packet en route between a client device and a server, the packet carrying secure-session-setup signaling to facilitate setup of a secure connection between the client device and the server. At block 502, the example method includes the meter reading, from the detected packet, a server IP address of the server and a server name of the server, and the meter establishing a correlation record that specifies for the client device a correlation of the server IP address with the server name. At block 504, the example method include the meter thereafter detecting packet-data communication en route between the client device and the server IP address, the detected packet-data communication excluding a plaintext indication of a name of the server with which the client device is communicating at the server IP address. And at block 506, the example method includes the established correlation record serving as a basis to determine that the name of the server is the server name specified by the correlation record, thereby facilitating recording the detected packet-data communication as being between the client device and the server having the server name.

In line with the discussion above, the secure connection in this example method could be a TCP secure session. Further, the secure-session-setup signaling could include a Client Hello message of a TLS protocol, with the Client Hello message carrying the server name in plaintext in an SNI field, in which case the act of reading the server name from the detected packet could involve reading the server name from the SNI field of the Client Hello message.

Further, the example method could involve the meter using the established correlation record as the basis to determine that the name of the server is the server name specified by the correlation record, and the meter recording the detected packet-data communication as being between the client device and the server having the server name (e.g., the meter recording that the packet-data communication is or was with that particular server).

Alternatively or additionally, the example method could involve the meter reporting to a back-end system the correlation record, and the meter concurrently or separately reporting to the back-end system the detecting of the packet-data communication en route between the client device and the server IP address. And the example method could involve the back-end system using the established correlation record as the basis to determine that the name of the server is the server name specified by the reported correlation record and the back-end system recording the detected packet-data communication as being between the client device and the server having the server name.

In addition, the example method could also involve establishing media-measurement data based on the recording of the detected packet-data communication as being between the client device and the server having the server name, and using the established media-measurement data as a basis to take action. For instance, this data could form a basis to establish ratings statistics, which could in turn form a basis for distribution of associated content, among other possibilities.

Further, the act of detecting the packet-data communication en route between the client device and the server IP address could involve detecting the packet-data communication en route through the secure connection between the client device and the server IP address. For instance, the packet-data communication could be an HTTPS message to or from the client device.

Still further, the meter could be external to the client device, in which case the act of detecting the packet and thereafter detecting the packet-data communication may both occur external to the client device. Or the meter could be internal to the client device, in which case the act of detecting the packet and thereafter detecting the packet-data communication may both occur internal to the client device.

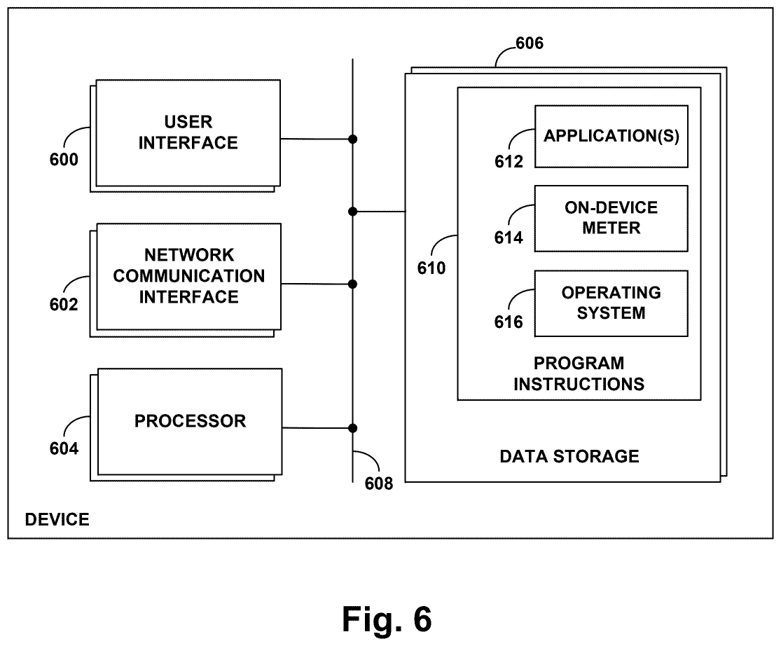

FIG. 6 is next a simplified block diagram of an example device such as the host device 126, that may be configured to carry out operations such as those discussed above. As shown in FIG. 6, the example device includes at least one user interface 600, at least one network communication interface 602, at least one processor 604, and non-transitory data storage 606, which could be integrated together in various ways and/or interconnected by a system bus, network, or other connection mechanism 608.

The at least one user interface 600 may comprise various components to facilitate interaction with a user of the device, such as with a panelist for instance. This may include output components such as a display and a sound speaker, and input components such as a touch-sensitive panel, a keyboard, and a microphone, which may work with associated drivers.

The at least one network communication interface 602 may comprise one or more interfaces facilitating communication with other devices, systems, and networks. For instance, the at least one network communication interface 602 may comprise a cellular wireless communication interface, a Wi-Fi communication interface, a Bluetooth communication interface, a wired Ethernet interface, and/or one or more other interfaces, which may work with associated drivers.

The at least one processor 604 may comprise one or more general purpose processors (e.g., microprocessors) and/or one or more specialized processors (e.g., digital signal processors (DSPs), graphics processing units (GPUs), neural processing units (NPUs), etc.) And the non-transitory data storage 606 may comprise one or more volatile and/or non-volatile storage components (e.g., flash, optical, magnetic, read only memory (ROM), random access memory (RAM) (e.g., dynamic RAM (DRAM), static RAM (SRAM), or double data rate RAM (DDRAM)), electronically programmable read only memory (EPROM), and/or electronically erasable programmable read only memory (EEPROM), etc.), which may be integrated in whole or in part with the processor 604 or may be provided separately.

As further shown, the non-transitory data storage 606 may store (e.g., hold or embody) program instructions 610. These program instructions may be executable by the processor 604 to cause the device to carry out various operations as described herein. As shown for instance, the instructions 610 may include applications 612, an on-device meter 614, and an operating system 616, any of which may also be integrated together as well or provided separately. Through execution of these instructions, the device may carry out various meter operations for instance.

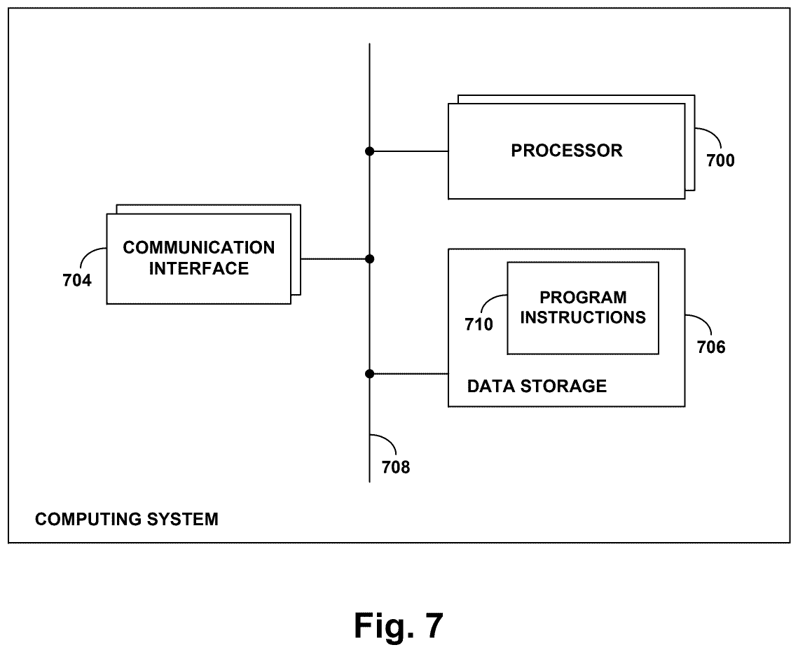

FIG. 7 is next a simplified block diagram of a computing system, which may be situated at or defined by the host device 126, the streaming meter 110, the media-measurement platform 124, and/or one or more other devices and/or systems such as but not limited to those described herein. For instance, some aspects of the computing system may be provided by one of the example meters, and other aspects may be provided by the media-measurement platform 124. or all aspects may be provided by an example meter, among other possibilities.

As shown in FIG. 7, the example computing system includes at least one processor 700, at least one communication interface 702, and non-transitory data storage 704, any or all of which may be integrated together to various extents and/or communicatively linked with each other by a system bus, network, or other connection mechanism 706.

The at least one processor 700 may include one or more general purpose processors (e.g., microprocessors) and/or one or more specialized processors (e.g., DSPs, GPUs, NPUs, etc.) The at least one communication interface 702 may comprise a network communication interface, perhaps a wired and/or wireless communication module, among other possibilities, to facilitate communicating with other entities. And the non-transitory data storage 704 may include one or more volatile and/or non-volatile storage components (e.g., flash, optical, magnetic, ROM, RAM) (e.g., DRAM, SRAM, or DDRAM), EPROM, and/or EEPROM, etc.), which may be integrated in whole or in part with the processor 700 or may be provided separately. As further shown, the data storage 704 may store program instructions 708, which may be executable by the processor 700 to carry out various computing system operations.

The present disclosure also contemplates, possibly separate from the other components noted above, non-transitory data storage (e.g., one or more non-transitory computer-readable medium components (e.g., flash, optical, magnetic, ROM, RAM) (e.g., DRAM, SRAM, or DDRAM), EPROM, and/or EEPROM, and/or other computer-readable media, etc.)) holding program instructions executable by at least one processor of a device to cause a computing system to carry out various operations described herein.

Further, the present disclosure likewise contemplates a computer program comprising a set of program instructions executable by at least one processor of a computing system to carry out (e.g., to cause the computing system to carry out) various operations described herein. In an example implementation, the computer program could further be stored in non-transitory data storage such as that noted above, among other possibilities.

Exemplary embodiments have been described above. Those skilled in the art will understand, however, that changes and modifications may be made to these embodiments without departing from the true scope and spirit of the invention.

What is claimed is:

1. A method comprising:
detecting, by a meter, a packet en route between a client device and a server, the packet carrying secure-session-setup signaling to facilitate setup of a secure connection between the client device and the server;
reading, by the meter, from the detected packet, a server Internet Protocol (IP) address of the server and a server name of the server, and establishing by the meter a correlation record that specifies for the client device a correlation of the server IP address with the server name; and
thereafter detecting, by the meter, packet-data communication en route between the client device and the server IP address, the detected packet-data communication excluding a plaintext indication of a name of the server with which the client device is communicating at the server IP address,
wherein the established correlation record serves as a basis to determine that the name of the server is the server name specified by the correlation record, thereby facilitating recording the detected packet-data communication as being between the client device and the server having the server name.

2. The method of claim 1, wherein the secure connection is a Transport Control Protocol (TCP) secure session.

3. The method of claim 2, wherein the secure-session-setup signaling comprises a Client Hello message of a Transport Layer Security (TLS) protocol, wherein the Client Hello message carries the server name in plaintext in a Server Name Indication (SNI) field, and wherein reading the server name from the detected packet comprises reading the server name from the SNI field of the Client Hello message.

4. The method of claim 1, further comprising:
using, by the meter, the established correlation record as the basis to determine that the name of the server is the server name specified by the correlation record; and
recording, by the meter, the detected packet-data communication as being between the client device and the server having the server name.

5. The method of claim 1, further comprising:
reporting, by the meter, to a back-end system the correlation record, and reporting by the meter to the back-end system the detecting of the packet-data communication en route between the client device and the server IP address;
using, by the back-end system, the established correlation record as the basis to determine that the name of the server is the server name specified by the reported correlation record; and
recording, by the back-end system, the detected packet-data communication as being between the client device and the server having the server name.

6. The method of claim 1, further comprising:
establishing media-measurement data based on the recording of the detected packet-data communication as being between the client device and the server having the server name; and
using the established media-measurement data as a basis to take action.

7. The method of claim 1, wherein detecting the packet-data communication en route between the client device and the server IP address comprise detecting the packet-data communication en route through the secure connection between the client device and the server IP address.

8. The method of claim 7, wherein the packet-data communication comprises a Hypertext Transfer Protocol Secure (HTTPS) message.

9. The method of claim 1, wherein the meter is external to the client device, and wherein detecting the packet and thereafter detecting the packet-data communication both occur external to the client device.

10. The method of claim 1, wherein the meter is internal to the client device, and wherein detecting the packet and thereafter detecting the packet-data communication both occur internal to the client device.

11. A computing system comprising:
at least one processor;
non-transitory data storage; and
program instructions stored in the non-transitory data storage and executable by the at least one processor to carry out operations including:
detecting a packet en route between a client device and a server, the packet carrying secure-session-setup signaling to facilitate setup of a secure connection between the client device and the server,
reading from the detected packet, a server Internet Protocol (IP) address of the server and a server name of the server, and establishing by the meter a correlation record that specifies for the client device a correlation of the server IP address with the server name, and
thereafter detecting packet-data communication en route between the client device and the server IP address, the detected packet-data communication excluding a plaintext indication of a name of the server with which the client device is communicating at the server IP address,
wherein the established correlation record serves as a basis to determine that the name of the server is the server name specified by the correlation record, thereby facilitating recording the detected packet-data communication as being between the client device and the server having the server name.

12. The computing system of claim 11, wherein the secure connection is a Transport Control Protocol (TCP) secure session.

13. The computing system of claim 12, wherein the secure-session-setup signaling comprises a Client Hello message of a Transport Layer Security (TLS) protocol, wherein the Client Hello message carries the server name in plaintext in a Server Name Indication (SNI) field, and wherein reading the server name from the detected packet comprises reading the server name from the SNI field of the Client Hello message.

14. The computing system of claim 11, wherein the operations additionally include:
using the established correlation record as the basis to determine that the name of the server is the server name specified by the correlation record; and
recording the detected packet-data communication as being between the client device and the server having the server name.

15. The computing system of claim 11, wherein the operations additionally include:
establishing media-measurement data based on the recording of the detected packet-data communication as being between the client device and the server having the server name; and
using the established media-measurement data as a basis to take action.

16. The computing system of claim 11, wherein detecting the packet-data communication en route between the client device and the server IP address comprise detecting the packet-data communication en route through the secure connection between the client device and the server IP address.

17. At least one non-transitory computer-readable medium having stored thereon program instructions executable by at least one processor to carry out operations comprising:
detecting a packet en route between a client device and a server, the packet carrying secure-session-setup signaling to facilitate setup of a secure connection between the client device and the server;
reading from the detected packet, a server Internet Protocol (IP) address of the server and a server name of the server, and establishing by the meter a correlation record that specifies for the client device a correlation of the server IP address with the server name; and
thereafter detecting packet-data communication en route between the client device and the server IP address, the detected packet-data communication excluding a plaintext indication of a name of the server with which the client device is communicating at the server IP address;
wherein the established correlation record serves as a basis to determine that the name of the server is the server name specified by the correlation record, thereby facilitating recording the detected packet-data communication as being between the client device and the server having the server name.

18. The at least one non-transitory computer-readable medium of claim 17, wherein the secure-session-setup signaling comprises a Client Hello message of a Transport Layer Security (TLS) protocol, wherein the Client Hello message carries the server name in plaintext in a Server Name Indication (SNI) field, and wherein reading the server name from the detected packet comprises reading the server name from the SNI field of the Client Hello message.

19. The at least one non-transitory computer-readable medium of claim 17, wherein detecting the packet-data communication en route between the client device and the server IP address comprise detecting the packet-data communication en route through the secure connection between the client device and the server IP address.

20. The at least one non-transitory computer-readable medium of claim 17, wherein the operations additionally include:
using the established correlation record as the basis to determine that the name of the server is the server name specified by the correlation record; and
recording the detected packet-data communication as being between the client device and the server having the server name.
